(19) United States
(12) Patent Application Publication
(10) Pub. No.: US 2009/0045271 A1
(43) Pub. Date: Feb. 19, 2009

(54) HANDHELD ELECTRIC PRESSURE WASHER

(75) Inventors: Gus ALEXANDER, Inverness, IL (US); Morgan P. McCarty, Hoffman Estates, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FAIP North America, Inc., Elk Grove Village, IL (US)

(21) Appl. No.: 12/093,915

(22) PCT Filed: Nov. 16, 2006
(86) PCT No.: PCT/US06/44654

§ 371 Date: May 15, 2008

Related U.S. Application Data
(60) Provisional application No. 60/737,229, filed on Nov. 16, 2005.

(51) Int. Cl. B08B 3/02

(52) U.S. Cl. 239/722

(57) ABSTRACT

A portable handheld pressure washer is provided that includes an electric motor and a pump that are contained within a housing that has a built-in handle with a trigger on an upper side of the housing. The pressure washer of the present invention can also include a discharge lance to which various cleaning nozzles or other cleaning implements can be attached.

### FIELD OF THE INVENTION

The present invention relates to washers which discharge pressurized fluid and, more particularly, to a handheld pressure washer.

### BACKGROUND OF THE INVENTION

Pressure washers utilize pressurized streams of fluid for a variety of cleaning projects. Typically, pressure washers are relatively bulky and heavy pieces of equipment that are powered by an internal combustion engine. Such pressure washers are also relatively expensive. There is a growing consumer demand for pressure washers that can be used in the household market. In a household, a standard garden hose is used for many cleaning applications. However, as compared to a pressure washer, a standard garden hose produces a stream of water at a relatively low pressure. As a result, a garden hose is not nearly as effective as a pressure washer in most cleaning applications.

Unfortunately, however, the size and cost of most conventional pressure washers used in the commercial market makes them unsuitable for household use. For example, standard commercial pressure washers can be difficult for most people maneuver through a home. The bulk and weight of commercial pressure washers also makes them difficult to store in a home.

### OBJECTS AND BRIEF SUMMARY OF THE INVENTION

In view of the foregoing, a general object of the present invention is to provide a handheld pressure washer that is suitable for use in the household market.

A related object of the present invention is to provide a pressure washer that is relatively compact and lightweight so as to be portable and easy to store. A further object of the present invention is to provide a pressure washer that is relatively inexpensive.

These and other objects are achieved by a portable handheld pressure washer that includes in an exemplary embodiment an electric motor and a pump that are contained within a housing that has a built-in handle with a trigger on an upper side of the housing. The pressure washer of the present invention can also include a discharge lance to which various cleaning nozzles or other cleaning implements can be attached.

Other objects and advantages of the invention will become apparent upon reading the following detailed description and upon reference to the drawings.

### BRIEF DESCRIPTION OF THE SEVERAL VIEWS OF THE DRAWING(S)

FIG. 1 is a perspective view of an illustrative handheld pressure washer according to the present invention.

FIG. 2 is a partially cutaway side view of the handheld pressure washer of FIG. 1.

FIG. 3 is an enlarged side view of the axial pump of the handheld pressure washer of FIG. 1.

FIG. 4 is a perspective view of the handheld pressure washer of FIG. 1 utilizing a water broom attachment.

### DETAILED DESCRIPTION OF THE INVENTION

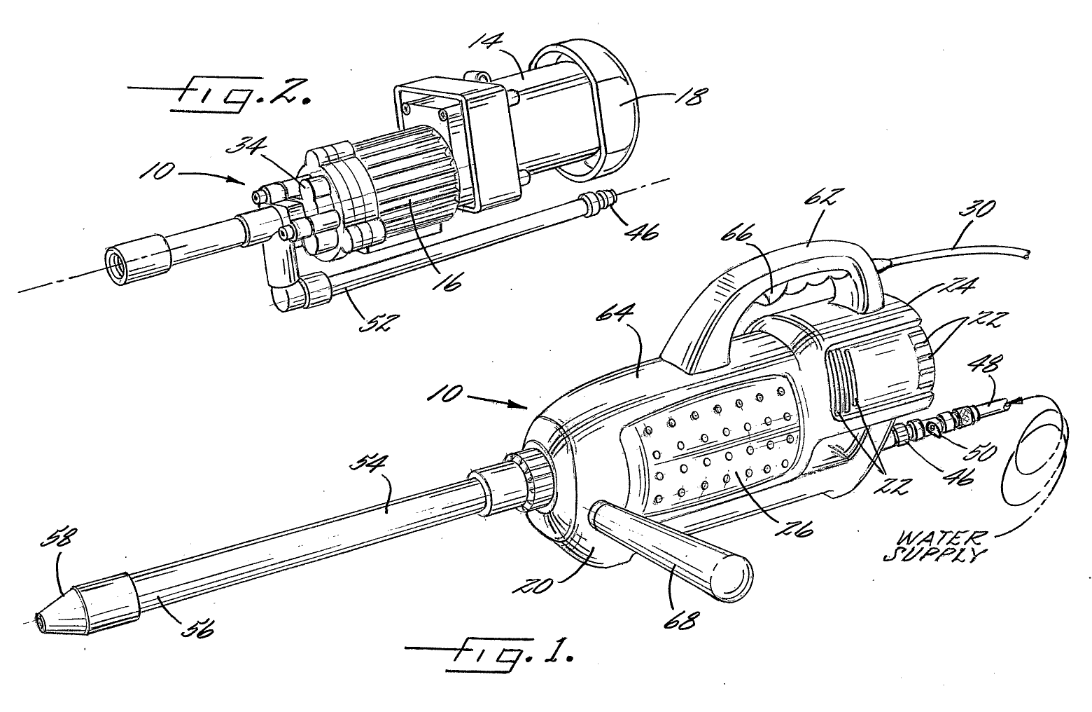

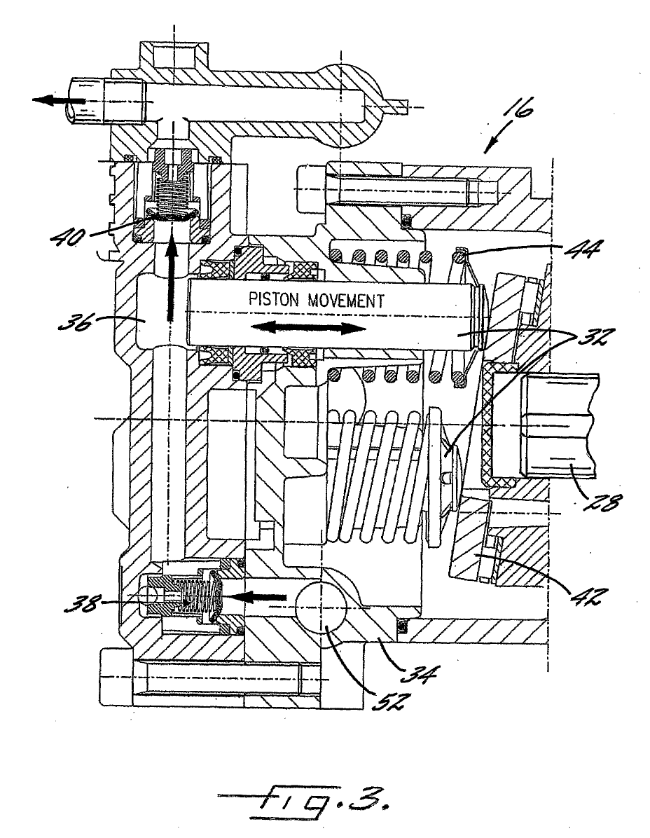

Referring now to FIG. 1 of the drawings, an illustrative handheld pressure washer 10 constructed in accordance with the teachings of the present invention is shown. The illustrated pressure washer includes a high pressure fluid pump system 12 that comprises an electric motor 14 and an axial pump 16 as shown in FIG. 2. The pump 16, electric motor 14 and an associated cooling fan 18 are all arranged within a housing 20 (shown in FIG. 1). The housing protects these electrically operated components from water infiltration and other damage.

The electric motor 14 can be of conventional design. In this case, the cooling fan 18 is arranged at a rear end of the pressure washer housing 20 and is operable through a number of vents 22 that are provided in the rear end 24 and sides 26 of the housing 20 as shown in FIG. 1. The electric motor 14 powers a drive shaft 28 that in this case extends in a longitudinal direction relative to the washer housing 20. The electric motor 14 in this case can be connected to an electric source via an electric cable 30 (see FIG. 1). The electric cable 30 will typically be a standard multiple lead insulated cord that terminates in a plug that is compatible with a household electric source.

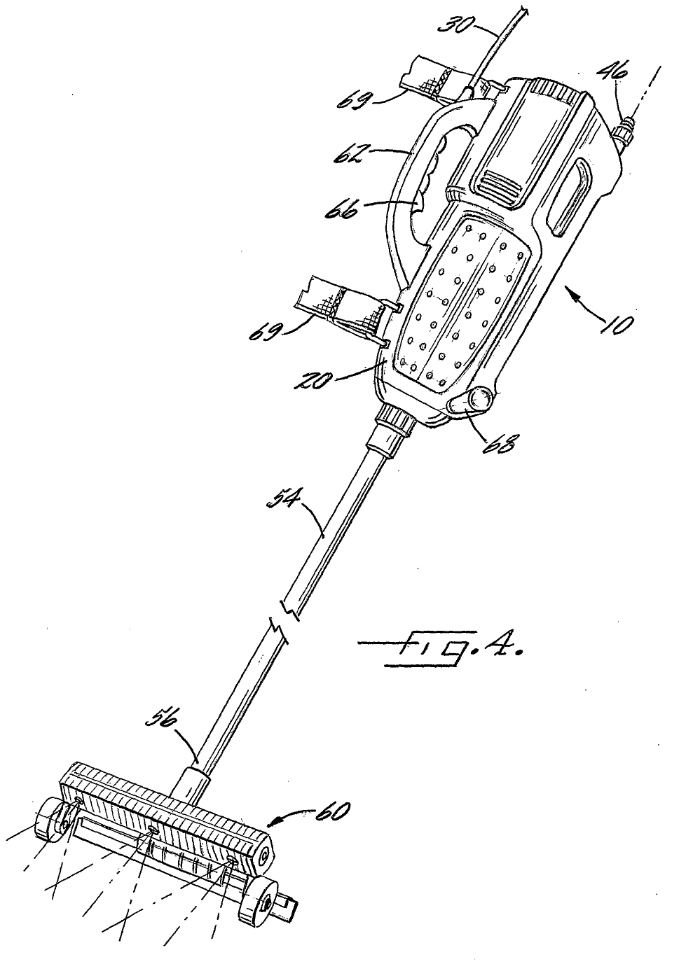

This drive shaft 28 powers the axial pump 16, which in one embodiment can operate at up to 3400 rpm. As shown in FIG. 3, the axial pump 16 includes a piston guide unit with conventional pistons 32 disposed within a pump housing 34. The illustrated axial pump 16 includes three pistons 32 that are displaced radially from one another. The pistons 32 are supported in respective piston chambers 36 for alternating movement in an axial direction parallel to the axis of the drive shaft 28. Each piston chamber 36 has associated inlet and outlet check valves 38, 40. The pistons 32 are driven via rotary movement of a cam or oscillating plate 42 which is fixed to the end of the drive shaft 28.

As the oscillating plate 42 rotates, the plate pushes a piston 32 forward and pressurizes fluid present in the respective piston chamber 36. The change of pressure in the piston chambers 36 operates the check valves 38, 40 that control the flow of fluid into and out of the axial pump 16. Once the oscillating plate 42 moves out of engagement with an individual piston 32, the piston is moved back to the start position by a compression spring 44. The operation of such an axial piston pump is known in the art and need not be described in further detail herein.

For connecting the pressure washer to a water supply, a water inlet connection 46 is provided near the rear end of the washer housing 20 as best shown in FIG. 1. In the illustrated embodiment, the water inlet 46 comprises a quick connect fitting that can be configured to attach to a water inlet line 48. In this case, the water inlet line 48 has a shut-off valve 50 adjacent the end. The water inlet connection 46 communicates with a feed line 52 that directs the fluid to the axial pump chamber (see FIG. 2). Advantageously, the pressure washer 10 can be designed to operate off of standard city water pressure and the water inlet line 48 can comprise a common household garden hose, making the pressure washer of the invention particularly suited for household use.

The pressurized fluid exiting the piston chambers 36 is directed to discharge lance 54 that extends outward from the forward end of the washer housing 20. The distal end 56 of the discharge lance 54 can be adapted to receive a variety of different cleaning attachments. For example, a directional cleaning nozzle 58 is attached to the distal end 56 of the lance 54 in the embodiment of FIGS. 1 and 2. As shown in FIG. 4, a wheeled water broom 60 could also be attached to the distal end 56 of the discharge lance 54. The illustrated water broom 60 is described in detail in the commonly owned pending U.S. application Ser. No. 11/095,805, the disclosure of which is incorporated herein by reference.

According to the invention, the motor 14 and pump 16 are relatively lightweight and compact in order to enable handheld operation of the pressure washer 10. To this end, for helping an operator manipulate and maneuver the pressure washer 10 more easily, the housing 20 includes a built-in handle 62. For ease of use, the handle 62 is arranged on an upper side 64 of the washer housing 20. In this case, the handle 62 has a closed design in which either end of the handle is attached to the upper side 64 of the housing 20 with a middle section that extends upward away from the washer housing so as to create a space between the handle and housing for an operator's hand.

A trigger 66 which controls operation of the pressure washer 20 is integrated into the lower side of the handle 62 for ease of use. In this case, the trigger 66 is designed to actuate the pressure washer 20 when the trigger is pulled upward toward the handle and away from the main body of the pressure washer housing 20. This movement of the trigger 66 is against the force of a biasing element such as a spring which normally biases the trigger to the lowered, off position. When an operator releases the trigger 66, the biasing element automatically moves the trigger back to the off position. To prevent the infiltration of water into the housing 20 through the trigger 66, the trigger can be covered by a flexible, waterproof material through which the trigger can still be operated. In this instance, the handle 62 is formed with grooves to better receive the fingers of an operator.

To further assist an operator in manipulating the pressure washer, the housing can include a side handgrip 68 as shown in FIG. 1. In the illustrated embodiment, the handgrip 68 comprises a post that extends laterally from the side of the washer housing 20. To enable the handgrip 68 to be switched between either side of the housing, the housing 20 is configured with receptacles on either side of the housing. The handgrip 68 can be removably attached to either of these receptacles by an operator as desired. The receptacle to which the handgrip 68 is not attached can be closed via a plug. If desired, a shoulder strap 69 (as shown in FIG. 4) could also be provided to assist an operator in supporting the pressure washer.

From the foregoing, it can be seen that the invention provides a pressure washer that is relatively lightweight and compact. This makes the pressure washer of the invention highly maneuverable and highly portable particularly as compared to conventional commercial grade pressure washers. In addition, the pressure washer of the invention is very easy-to-store and relatively cost effective. As a result, the pressure washer of the invention is particularly well suited for household applications. In such applications, the pressure washer of the invention can operate off standard city water pressure and produces much higher pressures than you would get from a standard household garden hose.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A handheld pressure washer comprising:
a housing,
an axial piston pump supported by said housing,
a liquid inlet connectable to a liquid supply and communicating with said axial piston pump,
an electric motor supported by said housing for operating said axial piston pump and pressurizing liquid received by said pump from said liquid inlet and for discharging a pressurized liquid stream from an outlet of said pressure washer, and
a handle affixed to said housing for enabling a user to manually hold and handle the pressure washer during usage without supporting the pressure washer on a floor surface or other supporting structure.

2. The handheld pressure washer of claim 1 in which said housing has an elongated configuration, and said electric motor has a shaft oriented parallel to a long axis of said housing.

3. The handheld pressure washer of claim 2 in which said axial piston pump includes a plurality of pistons operable for movement in respective axial directions parallel to said motor shaft.

4. The handheld pressure washer of claim 3 including a cam plate affixed to an end of said motor shaft for rotation with said motor shaft, and said pistons being axially movable in response to rotation of said cam plate.

5. The handheld pressure washer of claim 1 in which said handle is located on an upper side of said housing.

6. The handheld pressure washer of claim 4 including a trigger adjacent said handle for enabling a user holding said handle to selectively operate said motor and axial piston pump.

7. The handheld pressure washer of claim 6 in which said handle has a closed design that defines a space between the handle and housing for receiving an operator's hand.

8. The handheld pressure washer of claim 6 in which said trigger is disposed on an underside of said handle and is actuatable by pulling upwardly away from said housing.

9. The handheld pressure washer of claim 8 in which said trigger has a biasing element for biasing the trigger to a lowered off position.

10. The handheld pressure washer of claim 6 in which said trigger is covered by a flexible waterproof protective material through which the handle is operable.

11. The handheld pressure washer of claim 6 including a side handgrip affixed in projecting relation to a side of said housing for enabling a user to further support and handle the pressure washer during usage.

12. The handheld pressure washer of claim 11 in which said handgrip is removably attachable to either side of said housing.

13. The handheld pressure washer of claim 11 including a shoulder strap affixed to said housing for further assisting a user to support the weight of the pressure washer while enabling orientation to the pressure washer by means of said handle and handgrip.

14. The handheld pressure washer of claim 4 including a cooling fan arranged within a rear end of said housing and being operable by said motor, and said housing being formed with vents to permit the discharge of cooling air during operating of said pressure washer.

15. The handheld pressure washer of claim 1 including a lance connectable to said outlet having a spray nozzle at a distal end for directing a predetermined liquid spray discharge.

16. The handheld pressure washer of claim 1 including a water broom connectable to said outlet for movement along a floor surface to be cleaned while a user supports and carries the pressure washer by said handle.
